(19) United States
(12) Patent Application Publication
(10) Pub. No.: US 2026/0351544 A1
(43) Pub. Date: Nov. 5, 2026

(54) Ion trap for charged aerosol detector

(71) Applicant: Dionex Softron GmbH, Germering (DE)

(72) Inventors: Benjamin EGGART, Munich (DE); Alexandra SCHERZ, Munich (DE)

(21) Appl. No.: 19/198,229

(22) Filed: May 5, 2025

(51) Int. Cl. H01J 49/42; H01J 49/04

(52) U.S. Cl. CPC H01J 49/4255; H01J 49/045; H01J 49/427

(57) ABSTRACT

The present invention relates to an ion trap for aerosol filtering, comprising a housing comprising a housing inlet and a housing outlet, wherein the housing comprises a flow path between the housing inlet and the housing outlet; a rod, wherein a proximal portion of the rod is arranged in at least a portion of the flow path; an insulating member electrically insulating the rod from the housing; and a separation portion separating the insulating member from the flow path while allowing the rod to protrude into the flow path. Furthermore, the present invention relates to a charged aerosol detector (CAD) comprising such an ion trap as well as a method for removing ions from a charged secondary aerosol in a CAD.

### The present invention generally relates to charged aerosol detectors and particularly to an ion trap of a charged aerosol detector.

A charged aerosol detector (CAD) may generally comprise an ion trap which may be used for aerosol filtration. That is, the ion trap may generally be used to separate highly mobile ions from charged aerosol particles. In a CAD dried aerosol particles may generally be mixed with ions in a mixing chamber to transfer charges to the aerosol particles via diffusion. Subsequently, remaining ions are removed from the aerosol prior to detection. This may typically be achieved using an ion trap, wherein an electric field between a central rod and a surrounding housing is used to selectively push highly mobile charged particles towards the housing which is electrically connected to ground and thus charge neutral.

When charged particles (such as ions) hit the conductive, grounded housing of the ion trap, charges are immediately dissipated. However, known ion traps for CADs comprise an insulation to electrically disconnect the central rod from the housing, which may be disadvantageous for the removal of ions. In particular, if charges and/or charged particles are deposited on the insulation, it may be very difficult for the charges to dissipate. Once charges and/or charged particles have agglomerated at the insulation, they can be carried away again by a gas flow through the ion trap after an indefinite period of time and lead to incorrectly assigned signals in the detector and/or agglomerated charges and/or charged particles can disadvantageously influence charged aerosol particles due to their electric field. Furthermore, friction between a gas stream comprising the dried aerosol particles and ions and the insulation may also induce charges (through triboelectricity), which cannot dissipate at the insulation and may thus agglomerate.

In terms of design, it may be easiest to isolate the rod at an exit of the ion trap. However, disadvantageously this is also the most critical point because charges and/or charged particles placed there prevent or negatively influence the further transport of charges and, above all, small (highly mobile) aerosol particles. In particular, an agglomeration of charges and/or charged particles may generate an electric field that may negatively affect charged aerosol particles.

Generally, surfaces of the insulation exposed to charged particles may thus be kept as small as possible to minimize this problem. However, reducing the wall thickness of the insulation is contrary to their electrical insulating properties. In addition, slightly conductive materials can be used. Polyoxymethylene C SD is an example. It has very low conductivity. These properties may be sufficient to isolate the potential (e.g. +20 V) of the rod, but are also high enough to allow few charges to dissipate at its surface.

However, the material properties of such slightly conductive materials may be very batch-dependent. Manufacturers typically only specify a sheet resistance in a range of 10⁹ to 10¹¹ Ohm/sq. Depending on this value, the effect of charge-agglomeration dissipation or insulation from the rod dominates.

In light of the above, it is an object to overcome or at least alleviate the shortcomings and disadvantages of the prior art. More particularly, it is an object of the present invention to provide an improved ion trap for CADs, which may be less susceptible to agglomeration of charges and/or charged particles on insulating material.

These objects are met by the present invention.

In a first aspect, the present invention relates to an ion trap for aerosol filtering, comprising a housing comprising a housing inlet and a housing outlet, wherein the housing comprises a flow path between the housing inlet and the housing outlet. The ion trap further comprising a rod, wherein a proximal portion of the rod is arranged in at least a portion of the flow path, an insulating member electrically insulating the rod from the housing, and a separation portion separating the insulating member from the flow path while allowing the rod to protrude into the flow path.

In other words, the present invention provides an ion trap comprising a separation portion that separates the insulating member from the flow path. This may advantageously prevent the insulating member from being directly subjected to a (fluid) flow through the ion trap and thus reduce interaction between charged particles (e.g., ions or charged aerosol particles) and the insulating member and associated negative effects.

The ion trap may be configured to provide an electrical field between the rod and the housing. It will be understood that providing an electrical field may require providing voltage to the ion trap, e.g. the rod.

The proximal portion of the rod may be arranged concentrically in the at least a portion of the flow path. This may advantageously allow to provide a substantially homogenous electrical field within the ion trap (i.e., apart from any edge effects).

A distal portion of the rod may be electrically and mechanically connected to a connector, configured to provide a voltage to the rod.

The rod may comprise a rod diameter D_{R}. The rod diameter D_{R} may be in the range of 0.05 mm to 20 mm, preferably 0.5 mm to 10 mm, more preferably 1 mm to 2 mm.

The housing may comprise a chamber with a chamber inlet and a chamber outlet, and wherein the chamber constitutes part of the flow path. The chamber inlet may be fluidly connected to the housing inlet, preferably via a straight channel. In some embodiments, the chamber inlet may coincide with the housing inlet.

The proximal portion of the rod may be arranged in the chamber. Preferably, the proximal portion of the rod may be arranged concentrically in the chamber.

The chamber may comprise a circular symmetry around a rotational axis, and wherein the proximal portion of the rod may be arranged along the rotational axis of the chamber. For example, the chamber may comprise a cylindrical shape, and wherein the proximal portion of the rod may be arranged along the central axis of the chamber.

The rod may protrude through a distal end of the chamber into a chamber volume.

The chamber outlet may be arranged laterally at a distal end of the chamber. For example, the chamber outlet may be at a 90-degree angle with respect to a central axis of the chamber. The chamber outlet may be fluidly connected to the housing outlet, preferably via a straight channel.

The chamber may comprise a chamber length L_{C} along its largest extend in the range of 1 mm to 200 mm, preferably 10 mm to 50 mm, more preferably 20 mm to 30 mm. Additionally or alternatively, the chamber may comprise a chamber diameter D_{C} in the range of 1 mm to 100 mm, preferably 2 mm to 20 mm, more preferably 3 mm to 6 mm.

The housing may be electrically connected to ground. This may allow to establish an electrical field between the rod and the housing when the rod is supplied with a (preferably positive) voltage with respect to ground. Additionally, it allows for any charges deposited on a surface of the housing to dissipate.

The housing may be made of an electrically conductive material. Preferably, the housing may be made of a metal.

The separation portion may separate the insulating member from the chamber, while allowing the rod to protrude through the separating portion into the chamber. Thus, the insulating member may not be part of the chamber and particularly not constitute a portion of the chamber wall. This may advantageously reduce any interaction of charged particles with the insulating member and thus reduce and ideally prevent any agglomeration of charges and/or charged particles on the insulating member through diffusion and/or friction.

The separation portion may be arranged at a distal end of the chamber.

The separation portion may be electrically connected to the housing. In some embodiment the separation portion may be integrally formed with the housing.

A proximal surface of the separation portion may be oriented towards the chamber and form at least part of the boundary providing a distal end of the chamber. Additionally or alternatively, a distal surface of the separation portion may be oriented towards the insulating member.

The separation portion and particularly a distal surface thereof may be separated from the insulating member by an insulating gap. The insulating gap may be filled with air. In other words, the insulating gap may be an air gap. Alternatively, the insulating gap may be filled with a non-conductive glue, foam, or resin. Any liquid material that can be hardened may and that is non-conductive after being hardened may be viable.

The separation portion may comprise an orifice through which the rod can be guided without touching the separation portion. The orifice may comprise an orifice diameter D_{O}. The orifice diameter D_{O} may be larger than the rod diameter D_{R}. This may allow the rod to pass through the orifice without electrically contacting the separation portion. It will be understood, that the resulting gap between the separation portion and the rod may be considered to be part of the insulating gap and may for example also be filled with air or the non-conductive glue, foam, or resin.

The separation portion may comprise a thickness T_{S} in a proximal to distal direction, and wherein the Thickness T_{S} is in the range of 0.1 mm to 50 mm, preferably 1 mm to 10 mm, more preferably 1.8 mm to 2.2 mm.

The insulating member may be made of a Polyoxymethylene Copolymer (POM-C). Alternatively, the insulating member may be made of a ceramic.

The insulating member may be made of a material comprising a sheet resistance in the range of 10⁹ to 10¹¹ Ohm/sq. Additionally or alternatively, the insulating member may be made of a material comprising a volume resistance of at least 10⁹ Ohm cm.

The insulating member may be sealed to the housing. For example, an O-ring may be placed between the insulating member and the housing to establish a sealed connection therebetween. Additionally or alternatively, the connector may be sealed to the insulating member. Again, an O-ring may for example be placed between the insulating member and the connector to establish a sealed connection therebetween. Alternatively, a sealed connection may for example be achieved by glueing or press-fitting.

In another aspect, the present invention relates to a charged aerosol detector (CAD) comprising a nebulizer, a spray chamber comprising an impactor, a drying tube, a mixing chamber, a Corona charger, an electrometer, and an ion trap according to the present invention as for example described above. Preferably, the housing of the ion trap may be electrically connected to a common ground of the CAD.

In another aspect, the present invention relates to a method of removing ions from a charged secondary aerosol in a charged aerosol detector (CAD), comprising applying an electric field within the ion trap configured to remove highly mobile charged particles, and guiding the charged secondary aerosol through an ion trap of the CAD, wherein the charged secondary aerosol is not guided along a surface of insulating material.

The ion trap may be an ion trap according to the present invention and as for example described above.

Applying an electric field within the ion trap may comprise applying a positive voltage to a rod of the ion trap with respect to its housing, which may preferably be grounded. The positive voltage may be in the range of +10 to +30 V, preferably in the range of +15 to +25 V, such as +20 V.

Below, reference will be made to ion trap embodiments. These embodiments are abbreviated by the letter “I” followed by a number. Whenever reference is herein made to “trap embodiments”, these embodiments are meant.
I1. An ion trap for aerosol filtering, comprising
   a housing comprising a housing inlet and a housing outlet, wherein the housing comprises a flow path between the housing inlet and the housing outlet;
   a rod, wherein a proximal portion of the rod is arranged in at least a portion of the flow path;
   an insulating member electrically insulating the rod from the housing; and
   a separation portion separating the insulating member from the flow path while allowing the rod to protrude into the flow path.
I2. The ion trap according to the preceding trap embodiment, wherein the ion trap is configured to provide an electrical field between the rod and the housing.

It will be understood that providing an electrical field may require providing voltage to the ion trap, e.g. the rod.
I3. The ion trap according to any of the preceding trap embodiments, wherein the proximal portion of the rod is arranged concentrically in the at least a portion of the flow path.
I4. The ion trap according to any of the preceding trap embodiments, wherein a distal portion of the rod is electrically and mechanically connected to a connector, configured to provide a voltage to the rod.
I5. The ion trap according to any of the preceding trap embodiments, wherein the rod comprises a rod diameter D_{R}.
I6. The ion trap according to the preceding trap embodiment, wherein the rod diameter D_{R} is in the range of 0.05 mm to 20 mm, preferably 0.5 mm to 10 mm, more preferably 1 mm to 2 mm.
I7. The ion trap according to any of the preceding trap embodiments, wherein the housing comprises a chamber with a chamber inlet and a chamber outlet, and wherein the chamber constitutes part of the flow path.
I8. The ion trap according to the preceding trap embodiment, wherein the chamber inlet is fluidly connected to the housing inlet, preferably via a straight channel.
I9. The ion trap according to any of the 2 preceding trap embodiments, wherein the chamber inlet coincides with the housing inlet.
I10. The ion trap according to any of the 3 preceding trap embodiments, wherein the proximal portion of the rod is arranged in the chamber.
I11. The ion trap according to any of the 4 preceding trap embodiments, wherein the proximal portion of the rod is arranged concentrically in the chamber.
I12. The ion trap according to any of the 5 preceding trap embodiments, wherein the chamber comprises a circular symmetry around a rotational axis, and wherein the proximal portion of the rod is arranged along the rotational axis of the chamber.
I13. The ion trap according to any of the 6 preceding trap embodiments, wherein the chamber comprises a cylindrical shape, and wherein the proximal portion of the rod is arranged along the central axis of the chamber.
I14. The ion trap according to any of the 7 preceding trap embodiments, wherein the rod protrudes through a distal end of the chamber into a chamber volume.
I15. The ion trap according to any of the 8 preceding trap embodiments, wherein the chamber outlet is arranged laterally at a distal end of the chamber.
I16. The ion trap according to any of the 9 preceding trap embodiments, wherein the chamber comprises a chamber length L_{C} along its largest extend in the range of 1 mm to 200 mm, preferably 10 mm to 50 mm, more preferably 20 mm to 30 mm.
I17. The ion trap according to any of the 10 preceding trap embodiments, wherein the chamber comprises a chamber diameter D_{C} in the range of 1 mm to 100 mm, preferably 2 mm to 20 mm, more preferably 3 mm to 6 mm.
I18. The ion trap according to any of the 11 preceding trap embodiments, wherein the chamber outlet is fluidly connected to the housing outlet, preferably via a straight channel.

I19. The ion trap according to any of the preceding trap embodiments, wherein the housing is electrically connected to ground.

I20. The ion trap according to any of the preceding trap embodiments, wherein the housing is made of an electrically conductive material.

I21. The ion trap according to any of the preceding trap embodiments, wherein the housing is made of a metal.

I22. The ion trap according to any of the preceding trap embodiments and with the features of I7, wherein the separation portion separates the insulating member from the chamber, while allowing the rod to protrude through the separating portion into the chamber.

I23. The ion trap according to any of the preceding trap embodiments and with the features of I7, wherein the separation portion is arranged at a distal end of the chamber.

I24. The ion trap according to any of the preceding trap embodiments, wherein the separation portion is electrically connected to the housing.

I25. The ion trap according to any of the preceding trap embodiments, wherein the separation portion is integrally formed with the housing.

I26. The ion trap according to any of the preceding trap embodiments and with the features of I7, wherein a proximal surface of the separation portion is oriented towards the chamber and forms at least part of the boundary providing a distal end of the chamber.

I27. The ion trap according to any of the preceding trap embodiments, wherein a distal surface of the separation portion is oriented towards the insulating member.

I28. The ion trap according to any of the preceding trap embodiments, wherein the separation portion and particularly a distal surface thereof is separated from the insulating member by an insulating gap.

I29. The ion trap according to the preceding trap embodiment, wherein the insulating gap is filled with air.

I30. The ion trap according to the penultimate trap embodiment, wherein the insulating gap is filled with a non-conductive glue, foam, or resin.

I31. The ion trap according to any of the preceding trap embodiments, wherein the separation portion comprises an orifice through which the rod can be guided without touching the separation portion.

I32. The ion trap according to the preceding trap embodiment, wherein the orifice comprises an orifice diameter D_{O}.

I33. The ion trap according to the preceding trap embodiment and with the features of I5, wherein the orifice diameter D_{O} is larger than the rod diameter D_{R}.

I34. The ion trap according to any of the preceding trap embodiments, wherein the separation portion comprises a thickness T_{S} in a proximal to distal direction, and wherein the thickness T_{S} is in the range of 0.1 mm to 50 mm, preferably 1 mm to 10 mm, more preferably 1.8 mm to 2.2 mm.

I35. The ion trap according to any of the preceding trap embodiments, wherein the insulating member is made of a Polyoxymethylene Copolymer (POM-C).

I36. The ion trap according to any of the preceding trap embodiments, wherein the insulating member is made of a material comprising a sheet resistance in the range of 10⁹ to 10¹¹ Ohm/sq.

I37. The ion trap according to any of the preceding trap embodiments, wherein the insulating member is made of a material comprising a volume resistance of at least 10⁹ Ohm cm.

I38. The ion trap according to any of the preceding trap embodiments, wherein the insulating member is made of a ceramic.

I39. The ion trap according to any of the preceding trap embodiments, wherein the insulating member is sealed to the housing.

I40. The ion trap according to any of the preceding trap embodiments and with the features of I4, wherein the connector is sealed to the insulating member.

Below, reference will be made to CAD embodiments. These embodiments are abbreviated by the letter “C” followed by a number. Whenever reference is herein made to “CAD embodiments”, these embodiments are meant.

C1. Charged aerosol detector (CAD) comprising a nebulizer, a spray chamber comprising an impactor, a drying tube, a mixing chamber, a Corona charger, an electrometer, and an ion trap according to any of the preceding trap embodiments.

C2. Charged aerosol detector according to the preceding CAD embodiment, wherein the housing of the ion trap is electrically connected to a common ground of the CAD.

Below, reference will be made to method embodiments. These embodiments are abbreviated by the letter “M” followed by a number. Whenever reference is herein made to “method embodiments”, these embodiments are meant.

M1. Method of removing ions from a charged secondary aerosol in a charged aerosol detector (CAD), comprising applying an electric field within the ion trap configured to remove highly mobile charged particles, and guiding the charged secondary aerosol through an ion trap of the CAD, wherein the charged secondary aerosol is not guided along a surface of insulating material.

M2. Method according to the preceding method embodiment, wherein the ion trap is an ion trap according to any of the preceding trap embodiments.

M3. Method according to any of the preceding method embodiments, wherein applying an electric field within the ion trap comprises applying a positive voltage to a rod of the ion trap with respect to its housing, which may preferably be grounded.

M4. Method according to the preceding method embodiment, wherein the positive voltage is in the range of +10 to +30 V, preferably in the range of +15 to +25 V, such as +20 V.

Embodiments of the present invention will now be described with reference to the accompanying drawings. These embodiments should only exemplify, but not limit, the present invention.

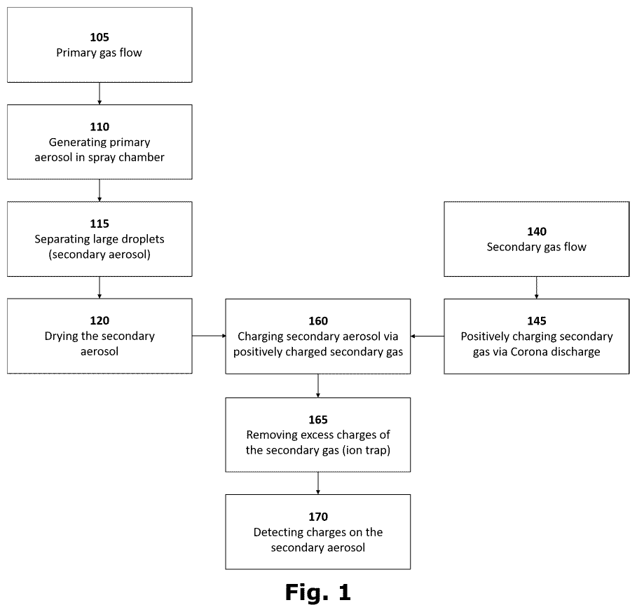

FIG. 1 depicts a flow diagram of charged aerosol detection;

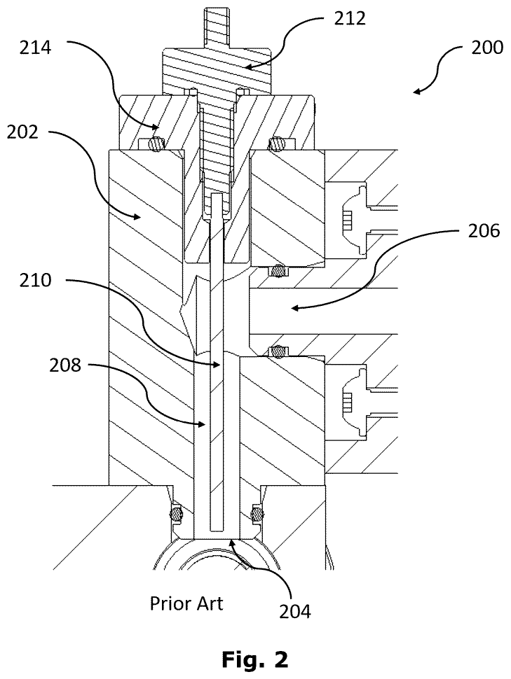

FIG. 2 depicts a prior art ion trap of a charged aerosol detector;

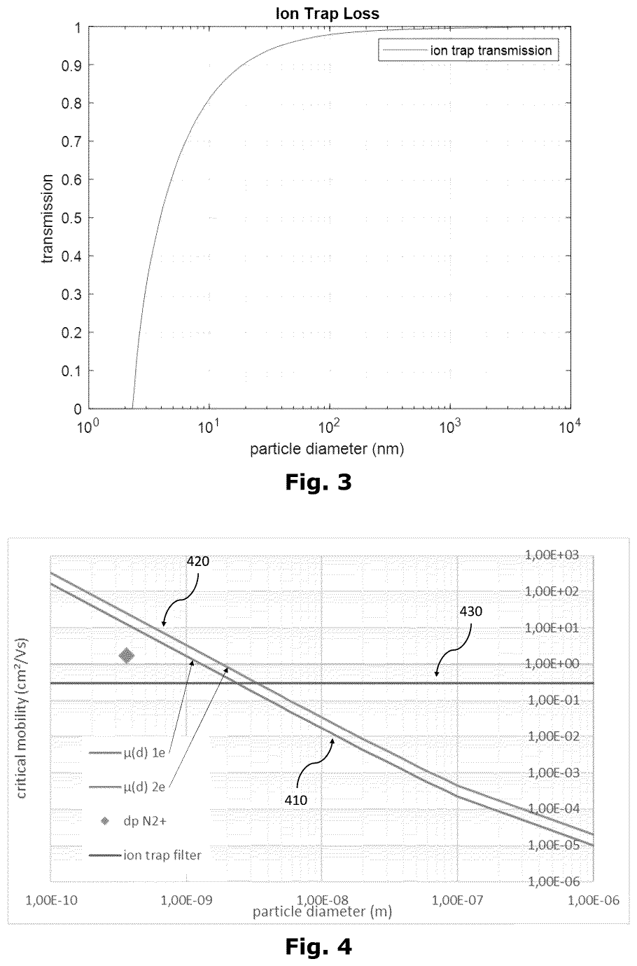

FIG. 3 illustrates the mobility of charged particles with respect to their size;

FIG. 4 illustrates the ion trap transmission; and

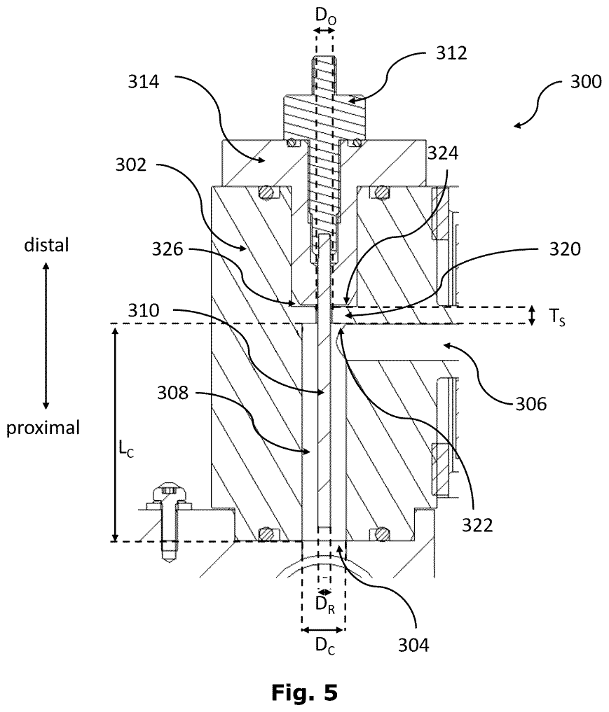

FIG. 5 illustrates an embodiment of an ion trap according to the present invention.

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

Very generally a charged aerosol detector (CAD) serves to measure the charge of an aerosol of an analyte, which may comprise particles with a diameter in the range of 10 nm to 100 μm. Prior to detecting the aerosol a few steps may typically be performed in a CAD.

While the principle of a CAD is generally known in the art, an exemplary very general workflow of a CAD is briefly discussed with reference to FIG. 1. Firstly, by aid of a primary gas flow 105 a primary aerosol of the analyte may be generated in a spray chamber through nebulization 110, e.g. pneumatic nebulization. Secondly, while the primary aerosol is guided through the spray chamber large droplets may be removed using an impactor to generate a secondary aerosol 115. Subsequently, the secondary aerosol may be dried 120, e.g. by guiding it through a heated evaporation tube.

A secondary gas flow 140 may be provided and the secondary gas may be positively charged via a Corona discharge 145. The positively charged secondary gas, e.g. nitrogen, and the dried secondary aerosol may then be mixed in a mixing chamber to charge the secondary aerosol by means of the positively charged secondary gas 160. Subsequently excess charges of the secondary gas may be removed 165, typically using an ion trap. Finally, charges on the secondary aerosol may be detected 170, e.g. within a faraday cup in a detection chamber.

The present invention concerns the ion trap and particularly an improvement of the ion trap to reduce and preferably prevent agglomeration of charges and/or charged particles (particularly ions) on insulating materials within the ion trap. It will be understood, that charges may agglomerated through effects such as triboelectricity and/or may be detached from charged particles hitting the insulating material. Additionally or alternatively charged particles may also agglomerate in case the charge does not separate from the particle. Agglomerated charges and/or charged particles may disadvantageously influence both positively and negatively charged particles and can potentially be carried away by particles after an undefined period of time, leading to incorrectly assigned signals in the detector. In the following reference may simply be made to charge agglomeration or agglomerated charges. It will be understood that this also refers to agglomeration of charged particles. That is, chare agglomeration and agglomerated charges refers to agglomeration of individual charges as well as charged particles.

With reference to FIG. 2 a typical ion trap of a CAD as known in the art is shown. The ion trap 200 may comprise a housing 202 comprising an inlet 204 and an outlet 206, such that the secondary aerosol (and remaining ions of the charged secondary gas) may flow through the inlet 204 into a chamber 208 defined by the housing 202 and may leave the chamber 208 and the housing 202 at the outlet 206, where it may preferably be guided to a Faraday cup for detection.

Furthermore, the ion trap may comprise a rod 210 electrically connected to a connector 212 and electrically insulated from the housing by means of an insulating member 214.

The rod may be at a positive potential of for example +20 V while the housing may be electrically connected to ground. Thus, positively charged particles may generally be deflected towards the housing 202 and away from the rod 210. Once a charged particle hits the housing 202, charges are dissipated to ground and in case of an ion, the neutral atom remains. Since it is not possible to discriminate between ions and charged aerosol particles, the electric field within the ion trap (and thus the potential applied to the rod 210 with respect to the grounded housing 202) is chosen such that only charged particles with a high mobility are filtered (i.e., are sufficiently deflected to hit the housing). Since the mobility correlates with the particle size this generally allows to provide a size (and charge) dependent transmission for charged particles, which can be tailored to filter out remaining ions of the secondary gas, while allowing for transmission of most of the charged aerosol particles.

With reference to FIG. 3, an exemplary, theoretical behaviour of an ion trap filter with respect to the particle diameter and mobility is shown. The horizontal, dark grey graph 430 depicts the critical mobility, i.e. a cutoff above which charged particles are filtered out, which is fixed for a chosen set of parameters (e.g., trap dimension, electrical field strength). The two sloping graphs 410, 420 depict the size-dependent mobility for particles with a single (410) and two (420) positive charges. That is, the lower sloping graph 410 depicts the ion mobility μ(d) in dependence of the particle diameter d for particles only carrying a single positive charge, while the upper sloping graph 420 depicts the ion mobility μ(d) in dependence of the particle diameter d for particles carrying two positive charges. In particular, this graph assumes a constant, size-independent charge of the respective particles. However, it will be understood that a larger particle diameter corresponds to a larger mass and consequently increased inertia, thus allowing larger particles to pass through the ion trap without being filtered out. The diamond indicates where a nitrogen molecule with a positive charge would be located on this graph. It can be seen that it lies above the cutoff and is thus filtered out by the ion trap. However, charged aerosol particles may typically comprise a size of at least 10 nm (10⁻⁸ m) and may thus at least largely be transmitted through the ion trap without filtering. However, it will be understood, that FIG. 3 merely represents a simplified theoretical example on how the particle mobility (and thus transmission of an ion trap) is affected by size and charge of particles. In particular, the mobility may generally decrease with particle size and increase with charge. For actual CADs the charge of a particle typically correlates with the particle size since larger particles comprise a larger surface area and may thus carry more charges.

In this regard reference can also be made to FIG. 4 depicting the effective particle-dependent ion trap transmission of an actual ion trap. That is, this graph depicts the actual particle transmission of an ion trap based on the actual size and consequently also charge of particles. It can be seen that the effective transmission at 10 nm is already above 80 %, while the effective transmission is 0 for charged particles with a size below 2 nm, such as nitrogen ions.

In other words, the ion trap of the CAD serves to separate highly mobile ions from charged aerosol particles. In an upstream mixing chamber of the CAD dried aerosol particles with a diameter of 10 nm to 100 μm are mixed with positively charged nitrogen ions. While in this mixture some of the positive charges of the nitrogen may be transferred to the aerosol particles via diffusion, some positive nitrogen ions may remain. In the ion trap, the remaining positive nitrogen ions are separated from the aerosol particles by means of an electric field. The electric field is generated via the rod 210, which may be located concentrically in the flow path, and the grounded walls of the flow path provided by the housing 202. The potential of the rod 210 may be +20 V. The positive nitrogen ions have a lower mass than the positively charged aerosol particles, which is why the electrical forces can easily deflect them from their flow trajectory. Once they have been deflected to the wall, their positive charge may flow off via the ground of the housing, which may correspond to the ground of the detector.

Again, the charged particles and particularly the ions may hit the insulating member 214, which may render it verry difficult for the charges to dissipate. Thus, charges and/or charged particles (particularly ions) may agglomerate at the insulating member 214, which is typically relatively close to the outlet 206. Subsequently, agglomerated charges and/or charged particles may randomly be carried away the gas flow towards the detector, resulting in incorrectly assigned signals.

With reference to FIG. 5 an embodiment of an ion trap according to the present invention is discussed. Generally, the ion trap 300 may comprise a housing 302 with a housing inlet 304 and a housing outlet 306, wherein the housing defines a flow path fluidly connecting the housing inlet 304 to the housing outlet 306. In particular, inner walls of the housing may define a flow path fluidly connecting the housing inlet 304 to the housing outlet 306.

Furthermore, the ion trap 300 comprises a rod 310 for generating an electric field between the rod 310 and the housing 302. The rod 310 may be electrically and mechanically connected to a connector 312. Furthermore, the rod 310 may be electrically insulated from the housing 302 by means of an insulating member 314. The rod 310 may generally be arranged within the flow path. Preferably, the rod 310 may be arranged concentrically in at least a portion of the flow path.

The insulating member 314 may be made of Polyoxymethylene Copolymer (POM-C). Preferably, the insulating member 314 may be made of a material comprising a sheet resistance in the range of 10⁹ to 10¹¹ Ohm/sq and a volume resistance of at least 10⁹ Ohm cm. Alternatively it may for example also be made of ceramic.

In particular, the flow path and thus also the housing 302 may comprise a chamber 308, wherein the electric field for filtering charged particles may be applied. Preferably the chamber 308 may comprise a cylindrical shape. The rod 310 may preferably be arranged concentrically within the cylindrical shape, i.e. it may run along an axis of the cylindrical chamber 308.

In the following the terms proximal and distal may be used. Generally, the proximal to distal direction may be defined with respect to the housing inlet 304 in that a part of the ion trap that is closer to the housing inlet 304 than another part is considered to be more proximal than the other part and vice versa. That is, referring to FIG. 5 the rod 310 may generally be considered more proximal than the connector 312.

Preferably, the housing inlet 304 may also constitute a proximal end of the chamber 308. The chamber 308 may comprise a chamber inlet, which may be fluidly connected to the housing inlet 304, preferably via a straight channel. In particular, the chamber inlet may coincide with the housing inlet 304. The rod 310 may protrude through a distal end of the chamber 308 into the chamber volume, preferably along a central axis of the chamber 308. This may advantageously allow to provide for a mostly uniform electrical field (apart from end regions of the rod 310). Thus, a proximal portion of the rod 310 may be located within the chamber 308, while a distal portion of the rod may for example be connected to the connector 312.

Furthermore, the chamber 308 may comprise a chamber outlet. The chamber outlet may be arranged laterally at the distal end of the chamber. Furthermore, the chamber outlet may be fluidly connected to the housing outlet 306, preferably via a straight channel. For example, the housing outlet may be arranged at a 90° angle to the housing inlet 304 and/or the chamber outlet may be arranged at a 90° angle to the chamber inlet.

The chamber 308 may comprise a chamber length L_{C} along its central axis in the range of 1 mm to 20 cm, preferably 10 mm to 50 mm, more preferably 20 mm to 30 mm The chamber 308 may preferably comprise a chamber diameter D_{C} in the range of 2 mm to 20 mm, more preferably 3 mm to 6 mm

Additionally, the ion trap 300 may comprise a separation portion 320 separating the insulating member 314 from the flow path and particularly the chamber 308 while allowing the rod 310 to protrude into the chamber 308. The separation portion 320 may be electrically connected to the housing 302. In particular, the separation portion 320 may be part of the housing 302 and may preferably be integrally formed with the housing 302. That is, a proximal surface 322 of the separation portion 320 may constitute part of the inner walls defining the flow path through the housing 302. A distal surface 324 of the separation portion 320 may be oriented towards the insulating member 314. The separation portion 320 and particularly the distal surface 324 may be separated from the insulating member 314 by an insulating gap 326. The separation portion 320 may comprise an orifice through which the rod 310 may be guided without touching the separation portion 320. The orifice of the separation portion may be centrally located in the separation portion and may generally comprise an orifice diameter D_{O} which may be larger than a rod diameter D_{R} such that the rod can pass through the separation portion 320 without any electrically conductive contact therebetween. D_{R} may be in the range of 0.05 mm to 20 mm. It will be understood, that the resulting gap between the separation portion 320 and the rod 310 may be considered to be part of the insulating gap 326.

The separation portion 320 may comprise a thickness T_{S} along the proximal to distal direction, i.e. between the proximal surface 322 and the distal surface 324. The thickness T_{S} of the separation portion may be in the range of 0.1 mm to 50 mm, preferably 1 mm to 10 mm, more preferably 1.8 mm to 2.2 mm.

The insulating gap 326 may for example be an air gap, i.e. it may be filled with air. Alternatively, it may be filled with an insulating material. For example, the insulating gap may be filled with a glue (e.g., two-component glue), foam, or resin. Any liquid material that can be hardened may and that is non-conductive after being hardened may be viable.

Thus, charge agglomeration at the chamber outlet and particularly at the insulating member 314 may be reduced and ideally even prevented by a combination of two measures. Firstly, the separation portion 320, preferably made of the housing material, is placed in front of the insulation of the rod at the ion trap potential, i.e. proximal of the insulating member 314. Secondly, an insulating gap 326, e.g. an air gap, is provided between the insulating member 314 and the separation portion 320.

An advantage of the separation portion 320 is that it may avoid an insulating surface (typically plastic) in the gas flow area. Consequently, no charge may be induced by friction or agglomerated. In addition, the dissipation of potentially agglomerated charges no longer depends on material properties of the insulator. Instead, the same electrical properties apply as in the chamber 308 of the ion trap and preferably as in the entire detector.

Additionally, the insulating gap 326 may advantageously prevent charges that dissipate via the surface of the separation portion to its distal surface 324 from agglomerating at the insulating member 314 Furthermore, the insulating gap may also be sealed such that the small dead volume distal of the separation portion 320 does not experience any significant gas flow. Thus, there may be no transport and it may be additionally prevented that any charges may be picked up and transported away from the insulating member 314. Thus, the combination of separation portion 320 and insulating gap 326 may prevent agglomeration of charges that may be harmful for a measurement. It will be understood, that at some point the insulating member 314 may be in contact with the housing 302, however, a potential agglomeration of charges at such a point may not pose a relevant problem for a measurement since such charges may not be picked up and transported away.

Thus, the present invention allows to avoid insulating materials within the chamber of the ion trap and particularly at the outlet of the ion trap. This allows to suppress and potentially even prevent agglomeration of ions and/or charges on the insulating materials while at the same time also preventing the insulating materials to be actively surrounded by the gas flow. Thus, the insulating material may be independent of the surface conductivity, allowing for usage of simpler, cheaper materials and avoiding reliance on materials with strongly fluctuating material properties. Furthermore, the lack of gas flow directly at the insulating material prevents any surface charges to be carried along.

Comparative measurements show a significantly improved transport of highly mobile particles for the present ion trap design in comparison to a state-of-the-art ion trap, which can be attributed to reduced interference of highly mobile particles with the insulating material of insulating member 314. For these measurements the respective ion trap was switched off (i.e., no electric field was applied), such that positively charged nitrogen ions in the gas flow were not filtered out but detected in a downstream measurement.

In some embodiments, the rod 310 and the insulating member 314 may be provided in a single piece made of composite material, which may for example be manufactured using two-component moulding.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. An ion trap for aerosol filtering, comprising
a housing comprising a housing inlet and a housing outlet, wherein the housing comprises a flow path between the housing inlet and the housing outlet;
a rod, wherein a proximal portion of the rod is arranged in at least a portion of the flow path;
an insulating member electrically insulating the rod from the housing; and
a separation portion separating the insulating member from the flow path while allowing the rod to protrude into the flow path.

2. The ion trap according to claim 1, wherein the housing comprises a chamber with a chamber inlet and a chamber outlet, and wherein the chamber constitutes part of the flow path.

3. The ion trap according to claim 2, wherein the separation portion separates the insulating member from the chamber, while allowing the rod to protrude through the separating portion into the chamber.

4. The ion trap according to claim 2, wherein the separation portion is arranged at a distal end of the chamber.

5. The ion trap according to claim 2, wherein a proximal surface of the separation portion is oriented towards the chamber and forms at least part of the boundary providing a distal end of the chamber.

6. The ion trap according to claim 1, wherein the separation portion is integrally formed with the housing.

7. The ion trap according to claim 1, wherein the separation portion and particularly a distal surface thereof is separated from the insulating member by an insulating gap.

8. The ion trap according to claim 1, wherein the insulating member is made of a Polyoxymethylene Copolymer (POM-C).

9. The ion trap according to claim 1, wherein the insulating member is sealed to the housing.

10. Charged aerosol detector (CAD) comprising a nebulizer, a spray chamber comprising an impactor, a drying tube, a mixing chamber, a Corona charger, an electrometer, and an ion trap, wherein the ion trap comprises
a housing comprising a housing inlet and a housing outlet wherein the housing comprises a flow path between the housing inlet and the housing outlet;
a rod, wherein a proximal portion of the rod is arranged in at least a portion of the flow path;
an insulating member electrically insulating the rod from the housing; and
a separation portion separating the insulating member from the flow path while allowing the rod to protrude into the flow path.

11. Method of removing ions from a charged secondary aerosol in a charged aerosol detector (CAD), comprising
applying an electric field within the ion trap configured to remove highly mobile charged particles, and
guiding the charged secondary aerosol through an ion trap of the CAD,
wherein the charged secondary aerosol is not guided along a surface of insulating material.
